(19) United States
(12) Patent Application Publication
(10) Pub. No.: US 2013/0260146 A1
(43) Pub. Date: Oct. 3, 2013

(54) Ultraviolet Radiation Crosslinking of Silicones

(71) Applicants: Robin E. Wright, Inver Grove Heights, MN (US); Margaux B. Mitera, New Richmond, WI (US); Jayshree Seth, Woodbury, MN (US)

(72) Inventors: Robin E. Wright, Inver Grove Heights, MN (US); Margaux B. Mitera, New Richmond, WI (US); Jayshree Seth, Woodbury, MN (US)

(73) Assignee: 3M INNOVATIVE PROPERTIES COMPANY, Saint Paul, MN (US)

(21) Appl. No.: 13/879,445

(22) PCT Filed: Oct. 13, 2011
(86) PCT No.: PCT/US2011/056064

§ 371 Date: Jun. 18, 2013

Related U.S. Application Data
(60) Provisional application No. 61/393,493, filed on Oct. 15, 2010.

(51) Int. Cl. C09D 183/04

(52) U.S. Cl. CPC C09D 183/04
USPC 428/345; 427/515; 524/588; 428/336

(57) ABSTRACT

Methods of crossliiiking functional and nonfunctional silicones are described. The methods include exposing the silicones to ultraviolet radiation having a spectrum comprising at least one intensity peak below 240 nm in an inert atmosphere. Articles prepared by such methods, including release liners and adhesive articles are also described.

### FIELD

The present disclosure relates to methods of crosslinking silicones using short wavelength ultraviolet radiation. Methods suitable for both functional and non-functional silicones are described.

### SUMMARY

Briefly, in one aspect, the present disclosure provides a method of making a crosslinked silicone layer. In some embodiments, the method comprises applying a layer of a composition comprising one or more non-acrylated polysiloxane materials on a substrate and exposing the layer to ultraviolet radiation having a spectrum comprising at least one intensity peak below 240 nm in an inert atmosphere. In some embodiments, the ultraviolet radiation has a spectrum comprising at least one intensity peak between 180 and 190 nm, inclusive. In some embodiments, the ultraviolet radiation has a spectrum comprising at least one intensity peak at less than 180 nm. In some embodiments, the ultraviolet radiation has a spectrum comprising at least one intensity peak between 170 and 175 nm, inclusive. In some embodiments, exposing the layer to ultraviolet radiation comprises exposing the layer to the radiant output of a low pressure mercury lamp, a low pressure mercury amalgam lamp, or a dixenon excimer lamp.

In some embodiments, at least one of the polysiloxane materials is a non-functional polysiloxane material. In some embodiments, each of the polysiloxane materials is a non-functional polysiloxane material. In some embodiments, at least one non-functional polysiloxane material is a poly(dialkylsiloxane), a poly(alkylarylsiloxane), or a poly(dialkyldiarylsiloxane).

In some embodiments, at least one of the polysiloxane materials is a functional polysiloxane material. In some embodiments, each of the polysiloxane materials is a functional polysiloxane material. In some embodiments, at least one of the functional polysiloxane materials is selected from the group consisting of vinyl-functional polysiloxane material and silanol-functional polysiloxane material.

In some embodiments, the composition comprises at least one non-functional polysiloxane material and at least one functional polysiloxane material, wherein the weight ratio of the functional polysiloxane materials to the non-functional polysiloxane materials is no greater than 1:1. In some embodiments, the weight ratio of the functional polysiloxane materials to the non-functional polysiloxane materials is no greater than 1:3.

In some embodiments, the inert atmosphere comprises no greater than 200 ppm oxygen, e.g., no greater than 50 ppm oxygen.

In some embodiments, the ultraviolet radiation source is selected to have a spectrum having at least one intensity peak at a wavelength where the absorbance of the layer is no greater than 0.5 as calculated by Beer's law. In some embodiments, the ultraviolet radiation source is selected to have a spectrum having at least one intensity peak at a wavelength where the absorbance of the layer is between 0.3 and 0.5, inclusive, as calculated by Beer's law.

In some embodiments, applying the layer on the substrate comprises a discontinuous coating.

In another aspect, the present disclosure provides a crosslinked silicone layer made according to the methods described herein.

In yet another aspect, the present disclosure provides an article comprising a substrate and a silicone layer adhered to at least a portion of at least one surface of the substrate, wherein the silicone layer comprises at least one ultraviolet radiation crosslinked non-acrylated polysiloxane material, wherein the ultraviolet radiation has a spectrum comprising at least one intensity peak below 240 nm. In some embodiments, the silicone layer comprises a first surface adjacent the at least one surface of the substrate and a second surface opposite the first surface, wherein the second surface is substantially free of oxidation. In some embodiments, the silicone layer is between 0.2 and 2 micrometers thick.

In some embodiments, the article further comprising an adhesive releasably adhered to the silicone layer. In some embodiments, the adhesive comprises an acrylic adhesive.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 illustrates an ultraviolet radiation curing chamber used in some embodiments of the present disclosure.

FIG. 2 illustrates an exemplary article according to some embodiments of the present disclosure.

### DETAILED DESCRIPTION

Generally, crosslinked silicones have a wide variety of uses including as release materials, adhesives, and coatings. Silicone materials have been polymerized or crosslinked using either thermal or moisture/condensation processes relying on the presence of specific types of catalysts and/or initiators. For example, platinum catalysts have been used with addition cure systems, peroxides (e.g., benzoyl peroxide) have been used with hydrogen-abstraction cure systems, and tin catalysts have been used with moisture/condensation cure systems.

Generally, these approaches have required reactive functional groups attached to the siloxane backbone of the silicone materials. For example, addition-cure, platinum-catalyzed systems generally rely on a hydrosilation reaction between silicon-bonded vinyl functional groups and silicon-bonded hydrogens. In general, it may be desirable to have a silicone system that can be cured without the use of these catalysts or initiators. It can also be useful to provide silicone systems that do not require specific functional groups for proper curing.

Electron-beam cured and UV-cured silicone release materials have also been used. Typically, these systems have also required the use of catalysts or initiators, including photoinitiators, along with specific functional groups. In particular, epoxy-functional and acrylate-functional silicones have been radiation cured in the presence of catalysts and initiators. Recently, International Publication Number WO 2010/056546 A1 (“Electron Beam Cured Silicone Release Materials,” Zoller, et al.) described crosslinking nonfunctional and functional silicone release materials using electron beam curing.

The present inventors have discovered new methods for crosslinking silicone materials, including those used to produce release layers. More specifically, the present inventors have discovered that both functional and nonfunctional silicones may be rapidly crosslinked by exposure to short wavelength ultraviolet radiation (UV radiation). As used herein, “short wavelength UV radiation” refers to ultraviolet radiation having a spectrum comprising at least one intensity peak at no greater than 240 nanometers (nm). In some embodiments, the short wavelength UV radiation has a spectrum comprising at least one intensity peak at no greater than 190 nm, e.g., between 180 and 190 nm, inclusive, between 183 and 188, inclusive, or even between 184 and 186 nm, inclusive. In some embodiments, the short wavelength UV radiation has a spectrum comprising at least one intensity peak at less than 180 nm, e.g., between 165 and 179 nm, inclusive; between 170 and 175 nm, inclusive, or even between 171 and 173 nm, inclusive.

In contrast to most previous methods for curing silicone materials, the methods of the present disclosure do not require the use of catalysts or initiators. Thus, the methods of the present disclosure can be used to cure compositions that are “substantially free” of such catalysts or initiators. As used herein, a composition is “substantially free of catalysts and initiators “if the composition does not include an “effective amount” of a catalyst or initiator. As is well understood, an “effective amount” of a catalyst or initiator depends on a variety of factors including the type of catalyst or initiator, the composition of the curable material, and the curing method (e.g., thermal cure, UV-cure, and the like). In some embodiments, a particular catalyst or initiator is not present at an “effective amount” if the amount of catalyst or initiator does not reduce the cure time of the composition by at least 10% relative to the cure time for the same composition at the same curing conditions absent that catalyst or initiator.

Generally, the silicone materials useful in the present disclosure are polysiloxanes, i.e., materials comprising a polysiloxane backbone. In some embodiments, the silicone materials can be described by the following formula illustrating a siloxane backbone with a variety of substituents:

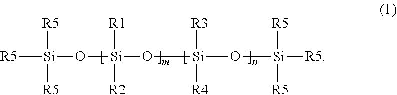

R1 through R4 represent the substituents pendant from the siloxane backbone. Each R5 may be independently selected and represent the terminal groups. Subscripts n and m are integers, and at least one of m or n is not zero.

In some embodiments, the silicone material is a nonfunctional polysiloxane material. As used herein, a “nonfunctionalized polysiloxane material” is one in which the R1, R2, R3, R4, and R5 groups are nonfunctional groups. As used herein, “nonfunctional groups” are either alkyl or aryl groups consisting of carbon, hydrogen, and in some embodiments, halogen (e.g., fluorine) atoms. In some embodiments, R1, R2, R3, and R4 are independently selected from the group consisting of an alkyl group and an aryl group, and R5 is an alkyl group. In some embodiments, one or more of the alkyl or aryl groups may contain a halogen substituent, e.g., fluorine. For example, in some embodiments, one or more of the alkyl groups may be —CH₂CH₂C₄F₉.

In some embodiments, R5 is a methyl group, i.e., the nonfunctionalized polysiloxane material is terminated by trimethylsiloxy groups. In some embodiments, R1 and R2 are alkyl groups and n is zero, i.e., the material is a poly(dialkylsiloxane). In some embodiments, the alkyl group is a methyl group, i.e., poly(dimethylsiloxane) (“PDMS”). In some embodiments, R1 is an alkyl group, R2 is an aryl group, and n is zero, i.e., the material is a poly(alkylarylsiloxane). In some embodiments, R1 is a methyl group and R2 is a phenyl group, i.e., the material is poly(methylphenylsiloxane). In some embodiments, R1 and R2 are alkyl groups and R3 and R4 are aryl groups, i.e., the material is a poly(dialkyldiarylsiloxane). In some embodiments, R1 and R2 are methyl groups, and R3 and R4 are phenyl groups, i.e., the material is poly(dimethyldiphenylsiloxane).

In some embodiments, the polysiloxane backbone may be linear. In some embodiments, the polysiloxane backbone may be branched. For example, one or more of the R1, R2, R3, and/or R4 groups may be a linear or branched siloxane with functional or nonfunctional (e.g., alkyl or aryl, including halogenated alkyl or aryl) pendant and terminal groups.

In some embodiments, the polysiloxane backbone may be cyclic. For example, the silicone material may be octamethylcyclotetrasiloxane, decmethylcyclopentasiloxane, or dodecamethylcyclohexasiloxane.

In some embodiments, the polysiloxane material may be functional. Generally, functional silicone systems include specific reactive groups attached to the linear, branched, or polysiloxane backbone of the starting material. For example, a linear “functionalized polysiloxane material” is one in which at least one of the R-groups of Formula 2 is a functional group.

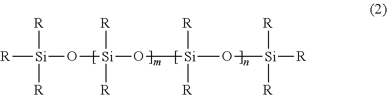

In some embodiments, a functional polysiloxane material is one is which at least 2 of the R-groups are functional groups. Generally, the R-groups of Formula 2 may be independently selected. In some embodiments, all functional groups are hydroxy groups and/or alkoxy groups. In some embodiments, the functional polysiloxane is a silanol terminated polysiloxane, e.g., a silanol terminated poly(dimethylsiloxane). In some embodiments, the functional silicone is an alkoxy terminated poly(dimethylsiloxane), e.g., trimethyl siloxy terminated poly(dimethylsiloxane).

Other functional groups include those having an unsaturated carbon-carbon bond such as alkene-containing groups (e.g., vinyl groups and allyl groups) and alkyne-containing groups.

In addition to at least one functional R-group, the remaining R-groups may be nonfunctional groups, e.g., alkyl or aryl groups, including halogenated (e.g., fluorinated) alky and aryl groups. In some embodiments, the functionalized polysiloxane materials may be branched. For example, one or more of the R groups may be a linear or branched siloxane with functional and/or non-functional substituents. In some embodiments, the functionalized polysiloxane materials may be cyclic.

Generally, the silicone materials may be oils, fluids, gums, elastomers, or resins, e.g., friable solid resins. Generally, lower molecular weight, lower viscosity materials are referred to as fluids or oils, while higher molecular weight, higher viscosity materials are referred to as gums; however, there is no sharp distinction between these terms. Elastomers and resins have even higher molecular weights than gums and typically do not flow. As used herein, the terms “fluid” and “oil” refer to materials having a dynamic viscosity at 25° C. of no greater than 1,000,000 mPa·sec (e.g., less than 600,000 mPa·sec), while materials having a dynamic viscosity at 25° C. of greater than 1,000,000 mPa·sec (e.g., at least 10,000,000 mPa·sec) are referred to as “gums”.

In order to obtain the low thicknesses generally desirable for some silicone coatings, e.g., silicone release materials, it is often necessary to dilute high molecular weight materials with solvents in order to coat or otherwise apply them to a substrate. In some embodiments, it may be preferable to use low molecular weight silicone oils or fluids, including those having a dynamic viscosity at 25° C. of no greater than 200,000 mPa·sec, no greater than 100,000 mPa·sec, or even no greater than 50,000 mPa·sec.

In some embodiments, it may be useful to use materials compatible with common solventless coating operations, including, e.g., those having a kinematic viscosity at 25° C. of no greater than 50,000 centistokes (cSt), e.g., no greater than 40,000 cSt, or even no greater than 20,000 cSt. In some embodiments, it may be desirable to use a combination of silicone materials, wherein at least one of the silicone materials has a kinematic viscosity at 25° C. of at least 5,000 centistokes (cSt), e.g., at least 10,000 cSt, or even at least 15,000 cSt. In some embodiments, it may be desirable to use silicone materials having a kinematic viscosity at 25° C. of between 1000 and 50,000 cSt, e.g., between 5,000 and 50,000 cSt, or even between 10,000 and 50,000 cSt.

In general, depending on the selected silicone material, including its viscosity, any known coating method may be used. Exemplary coating methods include roll coating, spray coating, dip coating, gravure coating, bar coating, and the like.

Once coated, the silicone material is exposed to short wavelength ultraviolet radiation. Excimer lamps have been used to provide monochromatic UV radiation. Suitable UV sources include any source of UV radiation, broadband or narrowband, having at least one peak in the wavelength range below about 240 nm. Such sources include UV lamps such as mercury lamps, xenon lamps, and excimer lamps and UV lasers such as excimer lasers. Such sources may be continuous or pulsed. Additionally, suitable sources may be focused or not focused.

Preferred short wavelength UV sources include excimer lamps such as a KrCl excimer lamp with output at 222 nm, a Xe₂ excimer lamp with output at 172 nm, and a low-pressure mercury lamp with output at 254 nm and 185 nm. An especially preferred lamp is a low-pressure mercury amalgam lamp with enhanced output at 185 nm. A single source or a plurality of sources may be used. In some embodiments, a combination of more than one type of short wavelength UV radiation source may be used. In some embodiments, a reflector may be used to increase the UV irradiance.

Short wavelength ultraviolet radiation has been used in the presence of oxygen to surface-modify a crosslinked silicone layer, for example, to create a silica surface. The present inventors have learned that short wavelength ultraviolet radiation may be used to cure an uncrosslinked polysiloxane material. The present inventors have further discovered that exposure of nonfunctional and functional siloxane materials to the short wavelength radiation in an inert atmosphere can result in cured silicone layers suitable for use as release materials with, e.g., pressure sensitive adhesives.

As used herein, an “inert” atmosphere refers to an atmosphere having an oxygen content of no greater than 500 ppm. In some embodiments, the inert atmosphere has an oxygen content of no greater than 200 ppm, or even no greater than 50 ppm. In some embodiments, the inert atmosphere may comprise an inert gas such as nitrogen. In some embodiments, the inert atmosphere may be a vacuum.

Although some embodiments of the present disclosure describe the use of functional silicone materials, the nature of the functional group is generally not critical to obtaining the desired crosslinked or cured polysiloxane materials. Although some reactions may occur through the functional groups, direct crosslinking between the polysiloxane backbones is often sufficient to obtain the desired degree of cure. In addition, in contrast to other curing procedures, including previous ultraviolet radiation curing procedures, in some embodiments, no catalysts or initiators are required to achieve the desired results. However, in some embodiments, catalysts or initiators may be included to, e.g., accelerate the cure.

### EXAMPLES

As summarized in Table 1, a wide variety of functional and nonfunctional silicone materials were evaluated.

TABLE 1
Silicone materials.

| Resin | Type | η, cSt | MW | Supplier |
|---|---|---|---|---|
| A | DC 200 PDMS | 1,000 | — | Dow Corning |
| B | DC 200 PDMS | 5,000 | — | Dow Corning |
| C | DC 200 PDMS | 10,000 | — | Dow Corning |
| D | DC 200 PDMS | 30,000 | — | Dow Corning |
| E | DC 200 PDMS | 100,000 | — | Dow Corning |
| F | DC 200 PDMS | 300,000 | — | Dow Corning |
| G | CR525B phenyl siloxane | — | — | GE |
| H | 3-0084 silanol-functional | 14,000 | — | Dow Corning |
| | PDMS | | | |
| I | OHX-4070 silanol- | 50,000 | — | Xiameter |
| | functional PDMS | | | |
| J | DMS-V41 vinyl- | 10,000 | 55k-70k | Wacker |
| | functional PDMS | | | |
| K | DMS-S42 silanol- | 18,000 | 70k-80k | Wacker |
| | functional PDMS | | | |
| L | DMS-V46 vinyl- | 20,000 | 100k-140k | Wacker |
| | functional PDMS | | | |

Each silicone material was used as received. The materials were coated out of hexane and dried in air before being exposed ultraviolet radiation. The dried but unexposed coatings could be streaked or marred when rubbed with a cotton-tipped applicator and were easily removed from the substrate when wiped with hexane, and are identified as “uncured.”

Coatings irradiated with ultraviolet radiation were tested to see whether sufficient curing had occurred by doing a Mar Test in which the surface was rubbed using a cotton-tipped applicator to see whether the surface smeared or marred. Coating were also evaluated with a Hexane Rub and Tape Peel Test in which an area of the silicone coating was wiped using either a tissue or cotton-tipped applicator soaked with hexane, followed by a tape peel test in which a strip of 810 Magic™ Tape (available from 3M Company) or masking tape was applied to the wiped area and the release level observed as the tape was peeled away. Exposed coatings were considered “cured” if they were mar-free after the Mar Test and showed good release properties following the Hexane Rub and Tape Peel Test. Curing implies that the coatings polymerized, crosslinked or underwent a combination of both. The tape peel test also provided an indication of the adhesion of the exposed coating to the substrate.

### Example Set A

### Exposure of Silicone Resins to 172 nm UV Radiation

### Example Set A1

### Non-Functional Silicone Materials (172 nm UV Radiation)

For Example Set A1, a 1% by weight coating solution of each of non-functional silicone materials A through G in hexane were prepared and coated on to the primed surface of a 127 micron (5 mil) think PET film using a No. 2 Mayer rod. Coating thickness after drying was estimated to be 50-100 nm.

Each sample was taped to a carrier tray and placed in a hood for at least one minute to remove hexane. The bottom third of the coated film was removed from each sample to save as an uncured reference. Next, the samples were set in a convection oven at 70° C. for 1-2 minutes. Immediately after removing from the oven, each sample was exposed monochromatic ultraviolet radiation source at a wavelength of 172 nm.

Samples irradiated at 172 nm were exposed using a dixenon excimer lamp from UV Solutions, Inc. mounted at a height of approximately 5 cm above a conveyor belt. The lamp and exposure zone were nitrogen purged to maintain an oxygen level of less than 50 ppm. No optical window separated the radiation source from the sample being exposed. The conveyer belt carried the samples at 1.5 m/minute (5 feet per minute) under the dixenon lamp operating at 8.00 kV.

Using the Mar Test, unexposed and exposed samples were rubbed with a cotton-tipped applicator. The unexposed samples marred and uncured, whereas the exposed samples did not mar. Additionally, the Hexane Rub and Tape Peel Test was performed to determine the adhesion of the coating to the backing and indicate whether the coating was soluble or insoluble in hexane. Regions of both an exposed and unexposed sample were rubbed with a hexane-soaked cotton-tipped applicator to try to remove the silicone coatings. A strip of masking tape was then applied to the washed area of each coating to compare the release levels. For each unexposed coating, the silicone coating washed away and the tape adhered to the substrate in the washed area. For each exposed sample, the silicone did not wash away and the tape easily released in both the washed and unwashed areas indicating that the coatings of each of EX-1 through EX-7 adhered and were cured.

### Example Set A2

### Functional Silicone Materials (172 nm UV Radiation)

The procedures used for Example Set A1 were repeated using silanol-functional PDMS (silicones H and I) and vinyl-functional PDMS (silicones J and L). In each case, the Mar Test and Hexane Rub and Tape Peel Test indicated that the unexposed samples were easily marred and removed with hexane. In contrast, none of the samples exposed to the 172 nm UV radiation were marred, and each retained its tape release after exposure to hexane.

### Example Set A3

### Use of Unprimed PET (172 nm UV Radiation)

The procedures used for Example Set A1 were repeated using silanol-functional PDMS (silicone I), vinyl-functional PDMS (silicone L), except that samples were coated onto both primed and unprimed PET film. Even when using unprimed PET, the coatings exposed to 172 nm UV radiation were mar-free when rubbed with a cotton-tipped applicator and retained good release properties after being rubbed with hexane.

### Example Set A4

### Effect of Coat Weight (172 nm UV Radiation)

At 1 wt. % solids, all of the dried coatings for Example Sets A1 through A3 were relatively thin, i.e., 50 to 100 nm. The effect of coating weight was studied using the solutions shown in Table 2 and the process of Example Set A1. After exposure to the 172 nm UV radiation source, all of the coatings failed the Mar Test. However, the surface of coatings made from some samples formed a thin skin layer, indicating a high absorbance of the 172 nm radiation and thus poor UV penetration into the bulk of the coating.

TABLE 2
Effect of coat weight upon exposure to 172 nm UV radiation.

| Silicone | Solids, | Hexane, | | Mar | Surface |
|---|---|---|---|---|---|
| Resin | wt. % | wt. % | Functionality | Test | skin |
| H | 30 | 70 | Silanol | Fail | no |
| I | 25 | 75 | Silanol | Fail | no |
| J | 30 | 70 | Vinyl | Fail | yes |
| K | 30 | 70 | Vinyl | Fail | yes |
| L | 25 | 75 | Vinyl | Fail | yes |
| L | 50 | 50 | Vinyl | Fail | yes |
| L | 75 | 25 | Vinyl | Fail | yes |

### Example Set A5

### Silicone Resin Blends (172 nm UV)

A blend of functional silicone resins was prepared from 50:50 blend by weight of silanol-functional silicone resin I and vinyl-functional silicone resin L at a total of 1 wt. % solids in hexane. A 50:50 blend by weight of nonfunctional silicone resins (resin A and resin G) was also prepared at 1 wt. % solids in hexane. These blended samples were coated and exposed to 172 UV radiation as described above. The blend of Resins I and L appeared cure as it passed the Mar Test and the Hexane Rub and Tape Peel Test. The blend of Resins A and G failed the Hexane Rub and Tape Peel Test. Phenyl groups are known to absorb near 172 nm, and this may have contributed to an increase in absorbance and a corresponding decrease in UV penetration and cure.

### Example Set A6

### Adhesive Release and Readhesion (172 nm UV)

Various silicone-coated PET films that were prepared and exposed to UV radiation at 172 nm as described. These samples were tested as release liner using a crosslinked acrylic copolymer adhesive (200 MP high performance acrylic adhesive, 3M Company, St. Paul, Minn.).

Sample Preparation. Samples were prepared for testing using either a Dry Lamination process or a Wet Casting process. For dry lamination, an adhesive tape was first prepared by either (a) coating the adhesive on a 50 micron (2.0 mil) primed PET film (product 3SAB from Mitsubishi) and drying the adhesive; or (b) laminating the adhesive to the 50 micron (2.0 mil) primed PET film. The adhesive of the resulting PET-backed tape was laminated to the release liner using two passes of a 2 kg rubber roller. For wet casting, the adhesive was coated directly on to the release coated liner and dried. The 50 micron PET film was then laminated to the dried adhesive forming the PET-backed tape adhered to a liner.

Sample Conditioning. Initial results were obtained at control conditions (“CT”) of 22° C. and 50% RH. Aged results were obtained after conditioning the samples for at high temperature (“HT”) conditions or 32.2° C. (90° F.) and 90% Relative Humidity. The number of days of conditioning is indicated for each test in the results reported below.

Release Test Procedure. PET-backed tape samples were peeled from the liner at an angle of 180° and at a rate of 230 cm/min (90 inches/minute). An IMass model SP2000 peel tester obtained from IMASS, Inc., Accord, Mass., was used to record the peel force.

Readhesion Test Procedure. To determine the readhesion value, PET-backed tape samples were peeled from the liner using the Release Test method and the tape was then applied to the surface of a clean stainless steel panel. The tape sample was rolled down against the panel by means of two passes with a 2 kg rubber roller at 61 cm/min (24 inches/min). The readhesion value was a measure of the force required to pull the tape from the steel surface at an angle of 180° at a rate of 30.5 cm/min (12 inches/minute). The IMass model SP2000 peel tester was used to record the peel force.

The results are summarized in Table 3.

TABLE 3
Release and readhesion results - silicones
exposed to 172 nm UV radiation.

| | | Release | | Readhesion | |
|---|---|---|---|---|---|
| | | (gm/25 mm) | | (gm/25 mm) | |
| Resin | Functional | Initial CT | 7 Day HT | Initial CT | 7 Day HT |
| A | No | 10.1 | 121 | 1210 | 923 |
| C | No | 11.0 | 191 | 942 | 883 |
| D | No | 9.3 | 217 | 951 | 1100 |
| E | No | 10.8 | 271 | 1010 | 857 |
| G | No | 12.8 | 823 | 1050 | 722 |
| I | Silanol | 9.0 | 103 | 1110 | 860 |
| I | Silanol | 10.1 | 427 | 1100 | 886 |
| 50:50 blend | Silanol | 12.2 | 260 | 931 | 945 |
| I and G | | | | | |

### Example Set B

### Exposure of Silicone Resins to 185 nm UV Radiation

### Example Set B 1

### Non-Functional Silicone Materials (185 nm UV Radiation)

For Example Set B1, a 1% by weight coating solution of each of non-functional silicone material E in hexane were prepared and coated on to the unprimed surface of a 127 micron (5 mil) think PET film using a No. 2 Mayer rod to prepare four samples. Coating thickness after drying was estimated to be less than 50 nm.

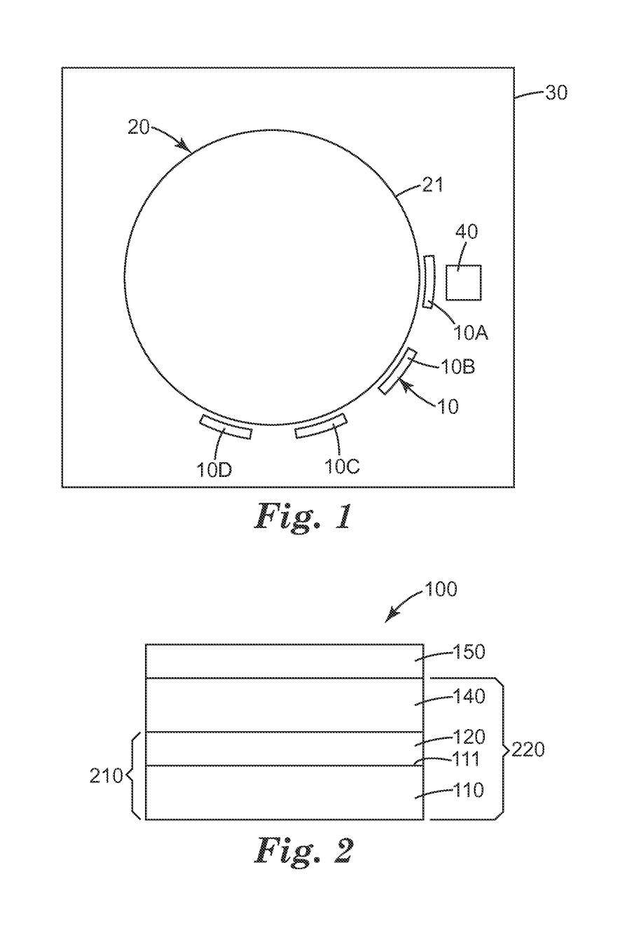

After the hexane had dried off, the four samples 10 were attached at various locations on the surface 21 of back up roll 20 located in vacuum chamber 30, as illustrated in FIG. 1. The chamber was closed and the system was evacuated. Low-pressure mercury lamps 40 were warmed up for approximately eleven minutes. Once the pressure in the chamber dropped to around 0.27 Pascal (2×10⁻³ Torr), back-up roll 20 was rotated to align first sample 10A with lamps 40, exposing the sample to UV radiation having an intensity peak at 185 nm for 30 seconds. The back-up roll was the rotated to align second sample 10B with lamps 40, and it was exposed for 60 seconds. Similarly, third sample 10C and fourth sample 10D were exposed for 120 and 240 seconds, respectively.

After the fourth sample was processed, the lamps were turned off and air was introduced back into the chamber. The four samples were removed and tested for marring according to the Mar test using cotton-tipped applicators. None of the samples marred.

Sample 10B, which was prepared from non-functional silicone resin E and had been exposed to 185 nm UV radiation for 30 seconds, was tested for release and readhesion. The results are summarized in Table 4.

TABLE 4
Comparison of Resin E exposed to 172 nm and 185 nm UV radiation.

| | UV | Release (gm/25 mm) | | Readhesion (gm/25 mm) | |
|---|---|---|---|---|---|
| Resin | radiation | 3 Day CT | 3 Day HT | 3 Day CT | 3 Day HT |
| E (*) | 172 nm | 10.8 | 271 | 1010 | 857 |
| E | 185 nm | 25.0 | 27.3 | 1160 | 1220 |

(*) From Data Set A5, Table 3.

### Example Set B2

### Effect of Exposure Time (185 nm UV Radiation)

Four additional samples were prepared using non-functional silicone resin E. The procedure described for Data Set B1 was followed, except the lamps were allowed to warm up for approximately 14 minutes. Exposure times of 5, 10, 15, and 30 seconds were used. Each of the samples appeared to be cured and none marred when subjected to the Mar Test. Each sample was tested for release and readhesion as described above, and the results are summarized in Table 5.

TABLE 5
Release and readhesion as a function of exposure time (185 nm UV).

| | Exposure | Release (gm/25 mm) | | Readhesion (gm/25 mm) | |
|---|---|---|---|---|---|
| Resin | time (sec) | 5 Day CT | 5 Day HT | 5 Day CT | 5 Day HT |
| E | 5 | 30.9 | 22.4 | 1240 | 1220 |
| E | 10 | 22.6 | 25.2 | 1250 | 1190 |
| E | 15 | 16.5 | N.T | 1370 | N.T |
| E | 30 | 33.0 | 37.3 | 1370 | 1340 |

(*) Not tested, coating defects.

### Example Set B3

### Continuous UV Radiation Exposure (185 nm UV Radiation)

Two additional samples were prepared using non-functional silicone resin E. The procedure described for Data Set B2 was followed, except the backup roll was continuously rotated and the exposure time was calculated based on the surface speed of the roll. Exposure times of 5, 10, 15, and 30 seconds were used. The samples were tested for release and readhesion as described above, and the results are summarized in Table 6.

TABLE 6
Release and readhesion at reduced exposure times (185 nm UV).

| | | | | | Readhesion | |
|---|---|---|---|---|---|---|
| | | | | | (gm/25 mm) | |
| | Roll speed | Exposure | Release (gm/25 mm) | | 5 Day | 5 Day |
| Resin | (m/min) | time (sec) | 5 Day CT | 5 Day HT | CT | HT |
| E | 6.1 | 1.3 | 16.3 | 28.9 | 1030 | 1150 |
| E | 3.0 | 2.6 | 13.7 | 18.6 | 1130 | 1080 |

### Example Set B4

### Continuous Coating and UV Radiation Exposure (185 nm UV Radiation)

Samples were prepared using Resin D (DC200 silicone, 30,000 centistokes, from Dow

Corning). A continuous coating and curing line was used to prepare samples at six different coat weights of resin. The silicone resin was applied to a 50 micron (2 mil) primed PET film using a 5-roll coater. The resin was exposed to UV radiation from a low pressure mercury lamp operating at 90 to 100° C. located about 9.5 mm above the resin. UV exposure was conducted in a nitrogen-inerted chamber (11 to 30 ppm oxygen). The release and readhesion results for both dry-laminated and wet-cast samples are summarized in Tables 7 and 8, respectively.

TABLE 7
Dry lamination release and readhesion results for Data Set B4.

| | | | | | Readhesion | |
|---|---|---|---|---|---|---|
| | | | | | (gm/25 mm) | |
| | Speed | Coat weight | Release (g/25 mm) | | 4 Day | 4 Day |
| I.D. | (m/min) | (gm/sqm) | 4 Day CT | 4 Day HT | CT | HT |
| B4-1 | 0.6 | 1.72 | 11.3 | 14.5 | 1280 | 1220 |
| B4-2 | 1.5 | 1.68 | 7.1 | 8.0 | 1090 | 1230 |
| B4-3 | 3.0 | 0.75 | 9.4 | 12.9 | 1190 | 1080 |
| B4-4 | 3.8 | 0.66 | 13.3 | 16.9 | 1080 | 1190 |
| B4-5 | 4.1 | 0.71 | 7.8 | 10.7 | 1160 | 1130 |

TABLE 8
Wet cast release and readhesion results for Data Set B4.

| | | | | | Readhesion | |
|---|---|---|---|---|---|---|
| | | | | | (gm/25 mm) | |
| | Speed | Coat weight | Release (g/25 mm) | | 4 Day | 4 Day |
| I.D. | (m/min) | (gm/sqm) | 4 Day CT | 4 Day HT | CT | HT |
| B4-1 | 0.6 | 1.72 | 19.1 | 28.9 | 1180 | 1080 |
| B4-2 | 1.5 | 1.68 | 13.5 | 14.5 | 1100 | 1160 |
| B4-3 | 3.0 | 0.75 | 21.3 | 21.7 | 1060 | 1110 |
| B4-4 | 3.8 | 0.66 | 23.7 | 21.3 | 1210 | 1250 |
| B4-5 | 4.1 | 0.71 | 16.4 | 18.5 | 1160 | 1200 |

Although 172 nm is closer to a peak in the absorption spectrum of polydimethyl siloxane, the present inventors discovered that ultraviolet radiation having a spectrum containing an intensity peak at 185 nm can provide better cure, particularly for thicker coatings. When curing a coating with actinic radiation, the selected wavelength must be absorbed but the level of absorption can not be so great as to prevent the actinic radiation from penetrating through the entire thickness of the coating.

In some embodiments, it is desirable to select an ultraviolet source having an intensity peak at a wavelength resulting in an absorbance greater than zero but no greater than 0.5, as determined by Beer's law for the particular silicone resin being cured and the thickness. When the absorbance goes above 0.5, a surface layer or skin may form due to the lack of penetration of the radiation through the coating thickness resulting in surface absorption and crosslinking. Absorbances below 0.3 are acceptable and tend to give more uniform penetration and cure profiles but are less efficient in terms of radiation capture. In some embodiments, the absorbance determined by Beer's law is between 0.3 and 0.5, inclusive, e.g., between 0.4 and 0.5, inclusive, or even between 0.40 and 0.45, inclusive. As the actual absorbance and the absorbance calculated by Beer's law increase linearly with thickness, a particular silicone resin may have the desired absorbance at one thickness, e.g., 1 micrometer, the absorbance of the same silicone resin at a greater thickness, e.g., 10 micrometers, may be too high.

Crosslinked silicone coatings prepared according to the methods of the present disclosure may be used in any of a wide variety of applications, including, e.g., as release layers, low adhesion backsize layers, coatings, and the like. Various exemplary applications are illustrated in FIG. 2. Article 100 comprises first substrate 110 and crosslinked silicone layer 120 adhered to first surface 111 of first substrate 110 forming release liner 210. In some embodiments, in addition to release liner 210, article 100 further comprises adhesive 140 releasably adhered to crosslinked silicone layer 120, forming transfer tape 220. In some embodiments, article 100 further comprises second substrate 150 adhered to adhesive 140, opposite crosslinker silicone layer 120.

In some embodiments, the second substrate may be a release liner, e.g., a release liner similar to release liner 210, and article 100 may be a dual-linered transfer tape. In some embodiments, the second substrate may be permanently bonded to the adhesive and adhesive article 100 may be, e.g., a tape or label.

Although not shown, in some embodiments, substrate 110 may be coated on both sides with a release material. In general, the release materials may be independently selected, and may be the same or different release materials. In some embodiments, both release materials are prepared according to the methods of the present disclosure. In some embodiments, self-wound adhesive articles may be prepared from such two-sided release liners. In some embodiments, one or primer layers may be included. For example, in some embodiments, a primer layer may be located at surface 111 of substrate 110.

Generally, substrates 110 and 150 may be any of a wide variety of commonly used materials. Exemplary materials include, paper, polycoated paper, polymer films (e.g., polyolefins, polyesters, and polycarbonates), woven and nonwoven fabrics, and metal foils. In some embodiments, the substrates may be surface treated (e.g., corona or flame treatment) or coated with, e.g., a primer or print receptive layer. In some embodiments, multilayer substrates may be used.

Generally, any known adhesive may be used including, e.g., natural and synthetic rubber, block copolymer, and polyolefin adhesives. In some embodiments, the adhesive may comprise an acrylic adhesive.

Various modifications and alterations of this invention will become apparent to those skilled in the art without departing from the scope and spirit of this invention.

1. A method of making a crosslinked silicone layer comprising: applying a layer of a composition comprising one or more non-acrylated polysiloxane materials on a substrate and exposing the layer to ultraviolet radiation wherein exposing the layer to ultraviolet radiation comprises exposing the layer to the radiant output of a low pressure mercury lamp or a low pressure mercury amalgam lamp.

2. The method of claim 1, wherein the ultraviolet radiation has a spectrum comprising at least one intensity peak between 180 and 190 nm, inclusive.

3-5. (canceled)

6. The method according to claim 1, wherein at least one of the polysiloxane materials is a non-functional polysiloxane material.

7. The method according to claim 1, wherein each of the polysiloxane materials is a non-functional polysiloxane material.

8. The method of claim 6, wherein at least one non-functional polysiloxane material is a poly(dialkylsiloxane), a poly(alkylarylsiloxane), or a poly(dialkyldiarylsiloxane).

9. The method according to claim 1, wherein at least one of the polysiloxane materials is a functional polysiloxane material.

10. The method according to claim 1, wherein each of the polysiloxane materials is a functional polysiloxane material.

11. The method according to claim 9, wherein at least one of the functional polysiloxane materials is selected from the group consisting of vinyl-functional polysiloxane material and silanol-functional polysiloxane material.

12. The method according to claim 9, wherein the composition comprises at least one non-functional polysiloxane material and at least one functional polysiloxane material, wherein the weight ratio of the functional polysiloxane materials to the non-functional polysiloxane materials is no greater than 1:1.

13. The method according to claim 12, wherein the weight ratio of the functional polysiloxane materials to the non-functional polysiloxane materials is no greater than 1:3.

14. The method according to claim 1, wherein the inert atmosphere comprises no greater than 200 ppm oxygen.

15. The method of claim 14, wherein the inert atmosphere comprises no greater than 50 ppm oxygen.

16. The method according to claim 1, wherein the ultraviolet radiation source is selected to have a spectrum having at least one intensity peak at a wavelength where the absorbance of the layer is no greater than 0.5 as calculated by Beer's law.

17. The method of claim 16, wherein the ultraviolet radiation source is selected to have a spectrum having at least one intensity peak at a wavelength where the absorbance of the layer is between 0.3 and 0.5, inclusive, as calculated by Beer's law.

18. The method according to claim 1, wherein applying the layer on the substrate comprises a discontinuous coating.

19. A crosslinked silicone layer made according to the method of claim 1.

20. A article comprising a substrate and a silicone layer adhered to at least a portion of at least one surface of the substrate, wherein the silicone layer comprises at least one ultraviolet radiation crosslinked non-acrylated polysiloxane material, wherein the ultraviolet radiation is conducted by exposing the silicone layer to the radiant output of a low pressure mercury lamp or a low pressure mercury amalgam lamp.

21. The article of claim 20, wherein the silicone layer comprises a first surface adjacent the at least one surface of the substrate and a second surface opposite the first surface, wherein the second surface is substantially free of oxidation.

22. The article according to claim 20, wherein the silicone layer is between 0.2 and 2 micrometers thick.

23. The article according to any one of claim 20, further comprising an adhesive releasably adhered to the silicone layer.

24. The article of claim 23, wherein the adhesive comprises an acrylic adhesive.
